(19) United States
(12) Patent Application Publication
(10) Pub. No.: US 2026/0229761 A1
(43) Pub. Date: Aug. 6, 2026

(54) SELF-CARRYING CONDUCTIVE STRIP FOR A TRANSMISSION LINE

(71) Applicant: Telefonaktiebolaget LM Ericsson (publ), Stockholm (SE)

(72) Inventors: Stefan JOHANSSON, Romelanda (SE); Jacob SAMUELSSON, Göteborg (SE); Jong Ho JUNG, Mölndal (SE)

(73) Assignee: Telefonaktiebolaget LM Ericsson (publ), Stockholm (SE)

(21) Appl. No.: 19/150,670

(22) PCT Filed: Jan. 26, 2023
(86) PCT No.: PCT/EP2023/051905

§ 371 Date: Jul. 24, 2025

(51) Int. Cl. H01P 3/08

(52) U.S. Cl. CPC H01P 3/084; H01P 3/087

(57) ABSTRACT

A conductive strip (210) for assembly with a first ground plane (220) to form a transmission line (200), a transmission line (200) comprising said conductive strip (210), a feed network (1900) comprising said transmission line (200), and an antenna arrangement (2000, 2100) comprising said feed network (1900). The conductive strip (210) comprises one or more conductive support legs (211). The one or more conductive support legs (211) are arranged to hold the conductive strip (210) positioned at a distance from the first ground plane (220) such that the transmission line (200) is configured to guide electromagnetic waves between the conductive strip (210) and the first ground plane (220) when the conductive strip (210) is assembled with the first ground plane (220).

### TECHNICAL FIELD

The present disclosure relates to the field of electromagnetic wave energy transmission, and, more particularly, to a conductive strip for a transmission line arranged to guide electromagnetic waves, a transmission line comprising said conductive strip, a feed network comprising said transmission line, and an antenna arrangement comprising said feed network.

### BACKGROUND

A transmission line is a structure configured to conduct electromagnetic waves in a contained manner, i.e., guide electromagnetic waves along a desired path. Low-loss transmission lines are of great importance for most radio and antenna applications. In a transmitter, it is crucial to minimize any losses in transmission lines between the antenna and the part generating radio frequency (RF) power (such as a power amplifier, PA) to ensure maximal radiated output power from the transmitter. Similarly, it is desired to minimize any losses in transmission lines between the antenna and the low noise amplifier in a receiver to ensure maximal receiver sensitivity. In the transmitter, transmission line losses may be compensated for by increasing the generated RF power. Such increase, however, is undesired since it increases PA design complexity and increases power consumption, which increases cost and cooling needs.

Array antennas typically comprise one or more feed networks of transmission lines for distributing the RF-signal (i.e. electromagnetic waves) to its antenna elements. For active array antennas, low-loss RF routing from the radio chains and the filters to the antenna elements is desired. In many cases, the active array antenna is build up by an array of sub-arrays. In such cases, it is particularly crucial to have low-loss sub-array feed networks.

There are different types of technologies for low-loss transmission lines. A common concept is to suspend a conductive strip in air between one or more ground planes, such an air stripline, as is shown in FIG. 1, or an air microstrip. Guiding electromagnetic waves in air between the conductive strip and the one or more ground planes significantly reduces losses compared to guiding the electromagnetic waves in a dialectic substrate.

One way of suspending the conductive strip is shown in FIG. 1, which shows an example air stripline. The air stripline in FIG. 1 comprises a dielectric substrate 130 suspended in a hollow rectangular conductive tube 140. The dielectric substrate comprises a first conductive strip 110 arranged on a surface of the dielectric substrate and a second conductive strip 120 arranged on a second surface of the dielectric substrate opposite to the first surface. This type of suspension, however, is relatively complex to implement in a printed circuit board (PCB). Another disadvantage with suspending the conductive strip on a dielectric substrate is that the dielectric substrate introduces some losses.

Another example of suspending a conductive strip in air using a substrate is disclosed by Kaixue Ma et. al., in “Recent Progress of Substrate Integrated Suspended Line based Antennas”, Proceedings 2018 IEEE Asia-Pacific Conference on Antennas and Propagation (APCAP), 2018, pp. 30-31. Li Ma et. al. show another similar air stripline suspended by a substrate in “A wideband filter-integrated coupler using substrate integrated suspended line (SISL) technology with patterned substrate,” 2018 International Applied Computational Electromagnetics Society Symposium-China (ACES), 2018, pp. 1-2.

In a yet another example, an air-suspended microstrip is formed by arranging the conductive strip on a separate plastic support structure that has been attached to a ground plane. The separate plastic support structure constitutes an additional part during assembly, compared to a conventional microstrip, which is undesired from a manufacturing point of view. Another disadvantage with suspending the conductive strip with a separate plastic support structure is that the separate plastic support introduces some losses.

Considering the disadvantages mentioned above, there is a need for improved means for guiding electromagnetic waves.

### SUMMARY

It is an object of the present disclosure to mitigate, alleviate or eliminate one or more of the above-identified deficiencies and disadvantages in the prior art and solve at least the above-mentioned problem. In particular, an object is to provide improved means for guiding electromagnetic waves. This object is obtained at least in part by a conductive strip for assembly with a first ground plane to form a transmission line. The conductive strip comprises one or more conductive support legs. The one or more conductive support legs are arranged to hold the conductive strip positioned at a distance from the first ground plane such that the transmission line is configured to guide electromagnetic waves between the conductive strip and the first ground plane when the conductive strip is assembled with the first ground plane.

The one or more conductive support legs enable a transmission line with a self-carrying conductive strip. In such transmission line, the space between the conductive strip and the first ground plane preferably comprises air, vacuum, or similar to enable a low-loss transmission line.

The fact that the disclosed conductive strip comprises the one or more conductive support legs eliminates the need for a separate support structure for suspension in a transmission line. Reducing the number of parts is particularly advantageous when producing transmission lines in large volumes. The disclosed conductive strip is also easy to manufacture. The ease of manufacturing and the reduction of the number of parts makes it cost-effective to manufacture transmission lines comprising the disclosed conductive strip.

The one or more conductive support legs further enable transmission lines with reduced losses compared to transmission lines using another conductive strip that is instead suspended by a dielectric substrate or plastic support structure.

According to some aspects, the one or more conductive support legs are arranged to be galvanically isolated from the first ground plane when the conductive strip is assembled with the first ground plane.

According to some aspects, at least one of the one or more conductive support legs is monolithically formed with the conductive strip. This way, manufacturing of the conductive strip is simple and cost-effective. As an example, the conducive strip may be manufactured from a stamped metal sheet, where the conductive support legs are bent after the stamping. In another example, the conductive support legs are formed as integral part of the conductive strip by casting. According to further aspects, all of the one or more conductive support legs are monolithically formed with the conductive strip.

According to some aspects, at least one of the one or more conductive support legs comprises a foot for soldering onto a conductive patch. This increases the contact surface between the conductive support leg comprising the foot and the surface it is assembled to. This increased contact surface facilitates soldering or other ways of attaching the conductive support leg to a surface.

According to some aspects, the one or more conductive support legs comprise a first conductive support leg arranged extending from a first side along the conductive strip and a second conductive support leg arranged extending from a second side along the conductive strip that is opposite to the first side. According to some other aspects, the one or more conductive support legs comprise a first conductive support leg arranged extending from a first side along the conductive strip and a second conductive support leg arranged extending from the first side. In any case, the first conductive support leg may be distanced from the second conductive support leg by (2n−1)x, where n is any integer and x is 0.2-0.3 wavelengths, and preferably 0.25 wavelengths, of a selected frequency. This spacing reduces the impact the first and the second conductive support legs have on the electromagnetic wave propagation properties, such as characteristic impedance, at the selected frequency of a transmission line comprising the conductive strip. If the conductive support legs are arranged on the both first and the second sides of the conductive strip, additional mechanical stability is obtained.

According to some aspects, the conductive strip is provided with at least one matching section adjacent to at least one of the one or more conductive support legs. A matching section is generally a section of the conductive strip with a shape that deviates from the remainder of the conductive strip such that the electromagnetic wave propagation characteristics of a transmission line comprising the conductive strip is locally affected. Consequently, the matching sections may compensate for parasitics (such as parasitic capacitances and/or parasitic inductances) introduced by the conductive support legs. According to additional aspects, the one or more conductive support legs comprise the first conductive support leg arranged extending from a first side along the conductive strip and the at least one matching section is arranged on a second side along the conductive strip that is opposite to the first side.

According to some aspects, the at least one matching section comprises an indentation and/or a bulge of the conductive strip. With such shapes, the conductive strip remains easy to manufacture.

There is also disclosed herein a transmission line comprising the conductive strip according to the discussions above assembled with the first ground plane. The transmission line is associated with the above-discussed advantages. In this transmission line, the conductive strip is arranged galvanically isolated from the first ground plane and at the distance from the first ground plane via the one or more conductive support legs such that the transmission line is configured to guide electromagnetic waves between the conductive strip and the first ground plane.

According to some aspects, at least one conductive patch is arranged in an opening on the first ground plane such that the at least one conductive patch is galvanically isolated from the first ground plane, wherein at least one of the one or more conductive support legs is soldered to one of the at least one conductive patch. This provides a simple way of attaching the conductive strip to the first ground plane. Furthermore, it is common to solder various components to e.g. a PCB in many circuit assembly processes. Consequently, soldering the conductive support legs of the disclosed conductive strip onto conductive patches is easy to implement in existing circuit manufacturing infrastructures. According to some other aspects, at least one of the one or more conductive support legs is attached to the first ground plane by an adhesive. In some manufacturing process, using an adhesive may be preferred compared to soldering.

According to some aspects, the transmission line further comprises a second ground plane arranged at a distance from the conductive strip such that transmission line is configured to guide electromagnetic waves between the conductive strip and the second ground plane. This way, a stripline type transmission line is formed. A stripline type transmission line present less dispersion and is shielded more compared to a microstrip type transmission line. According to some further aspects, the first ground plane, the second ground plane, and the conductive strip are arranged such that transmission line is configured to guide electromagnetic waves between a lower surface of the conductive strip and the first ground plane and between an upper surface of the conductive strip and the second ground plane, wherein the lower surface of the conductive strip is opposite to the upper surface of the conductive strip.

According to some aspects, the second ground plane is part of a folded conductive sheet attached to the first ground plane, where the folded conductive sheet is arranged to at least partly encapsulate at least part of the conductive strip between the first ground plane and the folded conductive sheet. This way, the second ground plane can easily be held in place with respect to the remainder of the transmission line. The folded conductive sheet also provides a compact transmission line compared to a case where the second ground plane is large conductive sheet arranged facing the first ground plane.

According to some aspects, the first ground plane is part of a printed circuit board (PCB). This provides a transmission line that is inexpensive to manufacture. In particular, the first ground plane may be an outermost layer, such as a metal foil, on the PCB.

According to some aspects, the transmission line comprises at least one signal transition from the conductive strip to the PCB. The signal transition may be used to direct electromagnetic waves guided by the transmission line to various components such as antenna elements or to other layers of the PCB.

There is also disclosed herein a feed network comprising at least one transmission line according to the discussions above. The feed network is associated with the above-discussed advantages. The feed network may comprise a plurality of transmission lines according to the discussions above, which form a power splitter and/or a power combiner.

There is also disclosed herein an antenna arrangement comprising at least one feed network according to the discussions above and at least one antenna element. The at least one feed network is arranged to guide electromagnetic waves to and/or from the at least one antenna element. The antenna arrangement is associated with the above-discussed advantages.

### BRIEF DESCRIPTION OF THE DRAWINGS

With reference to the appended drawings, below follows a more detailed description of embodiments of the present disclosure cited as examples. In the drawings:

FIG. 1 shows an example air stripline,

FIG. 2 shows an example transmission line,

FIG. 3A shows an example transmission line,

FIG. 3B shows an exploded view of the transmission line of FIG. 3A,

FIG. 4 is a schematic illustration of a conductive strip, and

FIGS. 5A-5B show different views of an example transmission line,

FIG. 5C shows a conductive support leg of the example transmission line of FIGS. 5A-5B,

FIGS. 6A-6B show different views of an air microstrip,

FIGS. 7 and 8 show return losses and transmission losses, respectively, of the transmission line of FIGS. 5A-5B and of the air microstrip of FIGS. 6A-6B,

FIGS. 9A-9B show different views of an example transmission line,

FIGS. 10A-10B show different views of an air stripline,

FIGS. 11 and 12 show return losses and transmission losses, respectively, of the transmission line of

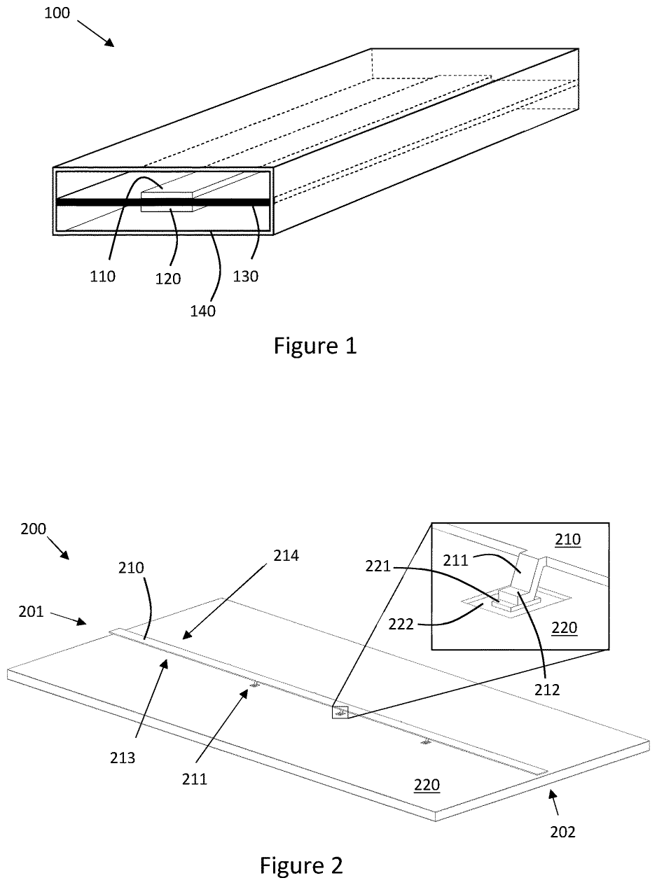

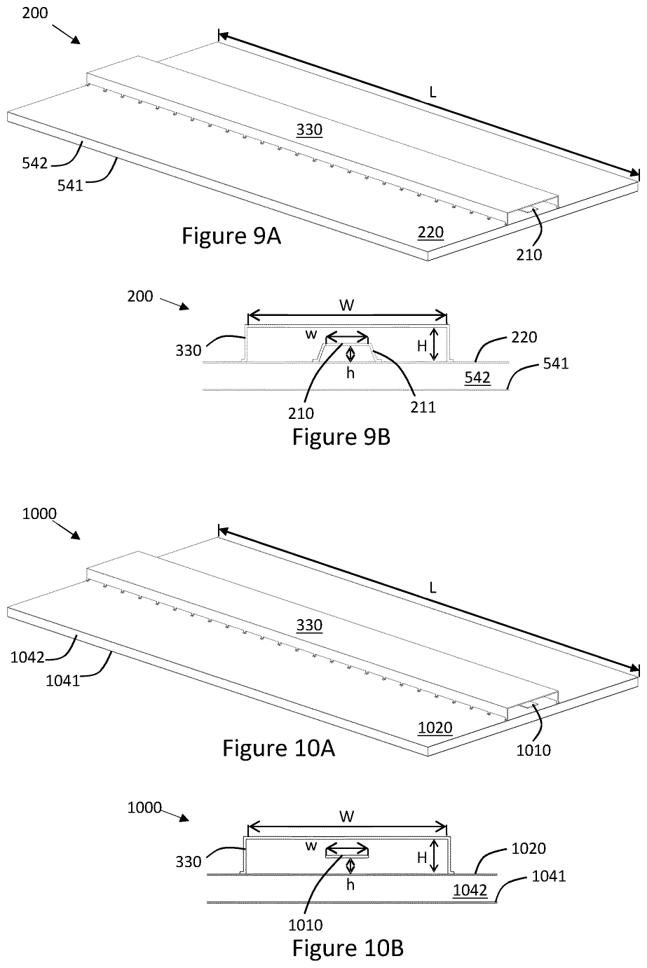

FIGS. 9A-9B and of the air stripline of FIGS. 10A-10B,

FIGS. 13A-13B show different views of an example transmission line arrangement and details of a signal transition,

FIGS. 14A-14B show different views of an example stripline,

FIGS. 15 and 16 show return losses and transmission losses, respectively, of the transmission line arrangement of FIGS. 13A-13B and of the stripline of FIGS. 14A-14B assuming a first dissipation factor,

FIGS. 17 and 18 show the return loss and the transmission loss, respectively, of the transmission line arrangement of FIGS. 13A-13B and of the stripline of FIGS. 14A-14B assuming a second dissipation factor,

FIG. 19 shows an example feed network, and

FIGS. 20-21 show respective example antenna arrangements.

### DETAILED DESCRIPTION

The present disclosure is described below with reference to the accompanying drawings, in which certain aspects of the present disclosure are shown. The present disclosure may, however, be embodied in many different forms and should not be construed as limited to the embodiments and aspects set forth herein; rather, these embodiments are provided by way of example so that this disclosure will be thorough and complete, and will fully convey the scope of the present disclosure to those skilled in the art. Like numbers refer to like elements throughout the description.

It is to be understood that the present disclosure is not limited to the embodiments described herein and illustrated in the drawings; rather, the skilled person will recognize that many changes and modifications may be made within the scope of the appended claims.

As mentioned, there is a need for improved means for guiding electromagnetic waves. Therefore, there is disclosed herein a conductive strip for assembly with a first ground plane to form a transmission line. There is also disclosed herein a transmission line comprising such conductive strip assembled with the first ground plane, where the conductive strip is arranged galvanically isolated from the first ground plane. Galvanic isolation between two electrical conductors means that there is no direct conduction path between the two electrical conductors.

With reference to FIG. 2, the disclosed conductive strip 210 comprises one or more conductive support legs 211. The one or more conductive support legs 211 are arranged to hold the conductive strip 210 positioned at a distance from the first ground plane 220 such that the transmission line 200 is configured to guide electromagnetic waves between the conductive strip 210 and the first ground plane 220 when the conductive strip 210 is assembled with the first ground plane 220.

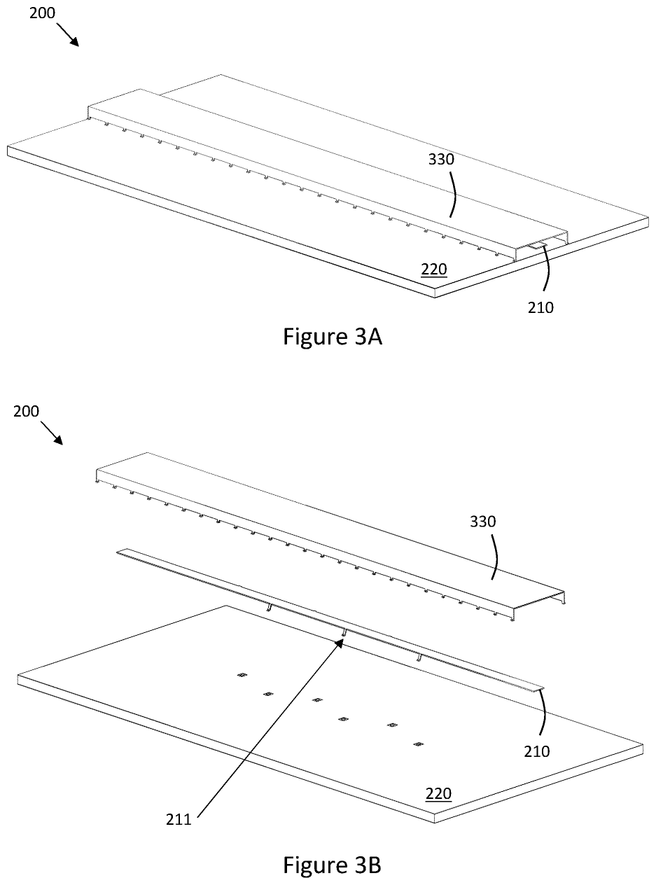

The conductive strip 210 is suitable for forming a transmission line such as a microstrip type transmission line or stripline type transmission line. FIG. 2 shows an example of a transmission line 200 that is a microstrip type transmission line. FIGS. 3A-3B shows an example of a transmission line 200 that is a stripline type transmission line. The conductive strip 210 may also be used for other types of transmission lines such as a coplanar type stripline.

The one or more conductive support legs 211 enable a transmission line 200 with a self-carrying conductive strip 210. The conductive support legs 211 may e.g. extend from the conductive strip 210 and be bent towards the first ground plane 220 such that the conductive strip 210 is held in a desired position relative to the first ground plane 220 when the conductive strip 210 is assembled with the first ground plane 220. The space between the conductive strip 210 and the first ground plane 220 preferably comprises air, vacuum, or similar to provide a low-loss transmission line. The disclosed conductive strip 210 thus enables a low-loss transmission line without the need for any lossy support structure, such as a plastic support structure or a dielectric superstrate support structure, which is advantageous since there is no need for any additional parts/components. The transmission line 200 enabled by the conductive strip 210 is also relatively easy to assemble. As a result, the transmission line 200 is cost-effective. The transmission line 200 may e.g. be formed on a printed circuit board (PCB) where a ground plane of the PCB constitutes the first ground plane 220.

The conductive strip 210 may be assembled with the first ground plane 220 in different ways. For example, the one or more conductive support legs 211 may be attached to the first ground plane by a galvanically isolating adhesive. In another example, the one or more conductive support legs 211 are soldered to respective conductive patches that are galvanically isolated form the first ground plane but mechanically connected to the first ground plane (e.g. by a substrate of a PCB). These different ways of assembling the conductive strip 210 with the first ground plane 220 are discussed in more detail below. Generally, the one or more conductive support legs 211 may be arranged to be galvanically isolated from the first ground plane 220 when the conductive strip 210 is assembled with the first ground plane 220.

As shown in the example of FIG. 2, the conductive strip 210 disclosed herein may be planar. However, other shapes of the conductive strip 210 are also possible, such as an arcuate shape. As is also shown in FIG. 2, the first ground plane 220 may be planar. The first ground plane 220 may also have other shapes, such as an arcuate shape. When both the conductive strip 210 and the first ground plane 220 are planar, the conductive strip 210 and the first ground plane 220 are preferably arranged parallel to each other when the conductive strip 210 is assembled with the first ground plane 220, as is shown in the example of FIG. 2.

The conductive strip 210 preferably is positioned such that the transmission line 200 is configured to guide electromagnetic waves between a bottom surface of the conductive strip 210 and the first ground plane 220 when the conductive strip 210 is assembled with the first ground plane 220. Here, the bottom surface is a surface facing the first ground plane 220.

In FIG. 2, the conductive strip 210 extends from a first end to a second end along an extension direction, where the first end forms a first port 201 together with the first ground plane 220, and where the second end forms a second port 202 together with the first ground pane 220. When the first port 201 is excited, electromagnetic modes propagate between the conductive strip 210 and the first ground plane 220 from the first port 201 to the second port 202.

The conductive strip 210 comprises a first side 213 along the extension direction of the conductive strip 210, and a second side 214 opposite to the first side 213. In FIG. 2, the first side 213 and the second side 214 are rectangles extending in respective planes that are perpendicular to the first ground plane 220 and parallel to the extension direction of the conductive strip 210.

As is also shown in the example of FIG. 2, the conductive strip 210 may have rectangular cross section in a plane perpendicular to its extension direction. Other cross sectional shapes are also possible. As is further shown in FIG. 2, the width of the conductive strip 210, measured in the same plane as the first ground plane and in a direction perpendicular to the extension direction of the conductive strip, may be substantially smaller than the length between the first and the second ports 201, 202. Although the electrical length of the transmission line 200 is typically substantially larger than the width of the conductive strip 210, any electrical length of the transmission line 200 is possible. The width of the conductive strip 210 is normally based on a desired characteristic impedance of the intended transmission line comprising the conductive strip 210, which in turn is normally dependent on the particular type of transmission line (such as microstrip type or stripline type). The width of the conductive strip 210 may be constant along the conductive strip 210. The width may alternatively vary along the conductive strip 210 and/or comprise local sections with different widths.

A conductive support leg 211 is an electrically conductive structure extending away from the conductive strip 210. A conductive support leg 211 may also be called a support pin. The conductive support leg 211 generally extends in an extension direction different from the extension direction of the conductive strip. The length of the conductive support leg 211 in its extension direction is selected such that a desired distance between the conductive strip 210 and the first ground plane 220 is obtained when the conductive strip 210 is assembled with the first ground plane 220. This distance is normally based on the desired characteristic impedance of the intended transmission line. The one or more conductive support legs 211 may be arranged to hold the conductive strip 210 positioned at a constant distance from the first ground plane 220 along the conductive strip 210. However, the one or more conductive support legs 211 may alternatively be arranged to hold the conductive strip 210 positioned at a varying distance from the first ground plane 220 along the conductive strip 210.

The thickness of the conductive strip 210, measured perpendicular to the width of the conductive strip 210, is preferably smaller than the width of the conductive strip 210. For example, the thickness may be less than a fifth of the width. The thickness may take on other values, however. The thickness of the conductive strip 210 may be constant along the conductive strip. The thickness may alternatively vary along the conductive strip and/or comprise local sections with different thicknesses.

In FIG. 2, the conductive strip 210 and the conductive support legs 211 have been formed from a single sheet and the conductive support legs 211 have been bent to form the self-carrying support. Before the bending of the conductive support legs 211, the conductive support legs 211 have a rectangular shape with the same thickness as the conductive strip 210. The length of said rectangle is selected, as mentioned above, to provide a desired distance between the conductive strip 210 and the first ground plane 220 when the conductive strip 210 is assembled with the first ground plane 220. In FIG. 2, the width of said rectangle, measured perpendicular to the length and perpendicular to the thickness of the rectangle, is smaller than the distance between the conductive strip 210 and the first ground plane 220 when the conductive strip 210 is assembled with the first ground plane 220.

Preferably, the widest dimension of the cross sectional shape of at least one of the one or more conductive support legs 211 is selected such that to the least one of the one or more conductive support legs 211 has little impact on the electromagnetic wave propagation in a transmission line 200 comprising the conductive strip 210. For example, the widest dimension of the cross sectional shape of at least one of the one or more conductive support legs 211 may be less than the distance between the conductive strip 210 and the first ground plane 220 when the conductive strip 210 is assembled with the first ground plane 220. Larger values of this widest dimension are possible. This widest dimension is a design choice and may e.g. be selected as larger values than the distance between the conductive strip 210 and the first ground plane 220 when the conductive strip 210 is assembled with the first ground plane 220 when more mechanical stability is desired, even if such values of the widest dimension have larger impact on the electromagnetic wave propagation in a transmission line 200 comprising the conductive strip 210.

The cross sectional shape of the conductive support legs 211 may have other shapes than the rectangular shape shown in FIG. 2. For example, a conductive support leg 211 may have a circular cross section. With such circular cross section, the conductive support leg 211 may also be bent in a similar way as the conductive support legs 211 shown in FIG. 2.

The conductive strip 210 may be made from a metal such as copper or gold, or from a non-conducting material like a polymer coated with a thin layer of a conducting material like gold or copper. The conductive strip 210 may alternatively be made from a material with an electric conductivity comparable to that of a metal, such as a carbon nanostructure. For example, the electric conductivity of the conductive strip 210 can be more than 10³ Siemens per meter (S/m), and preferably more than 10⁵ S/m.

A ground plane is an electrically conductive surface and is preferably electrically connected to electrical ground. As an example, a ground plane may be part of a PCB, and may in particular be an area of foil of the PCB that is electrically connectable to a power supply ground terminal or such. All ground planes disclosed herein may be made from the same materials as the conductive strip 210.

As mentioned, the fact that the conductive strip 210 comprises the one or more conductive support legs 211 eliminates the need for a separate support structure for suspending the conductive strip 210 in a transmission line 200. According to some aspects, at least one of the one or more conductive support legs 211 is monolithically formed with the conductive strip 210. In other words, the at least one of the one or more conductive support legs 211 is integrally formed with the conductive strip 210. The at least one of the one or more conductive support legs 211 integrally formed with the conductive strip 210 is thus a part of the conductive strip. As an example, the conductive strip 210 and the conductive support legs 211 may be formed from a single metal sheet. In that case, an initial shape may have been stamped out, where the conductive support legs 211 are subsequently bent. In another example, the conductive support legs are formed as integral part of the conductive strip by casting. According to further aspects, all of the one or more conductive support legs are monolithically formed with the conductive strip.

The conductive strip 210 may be assembled with the first ground plane 220 in different ways, such as using soldering or adhesives. In particular, as is shown in the example of FIG. 2, at least one of the one or more conductive support legs 211 may comprise a foot 212 for soldering onto a conductive patch 221. The foot of a conductive support leg 211 may e.g. be formed by bending that conductive support leg 211. The foot is a structure increasing the contact surface between its conductive support leg 211 and the conductive patch 221 or other surface the foot is assembled to. The foot consequently facilitates soldering. The foot is also suitable for attaching the conductive support leg 211 to any surface using an adhesive.

As mentioned, the conductive strip 210 comprises a first side 213 and a second side 214, as is shown in FIG. 2. All conductive support legs 211 may be arranged on the same side, such as the first side 213. Alternatively, the conductive support legs 211 may be arranged on the first and second sides 213, 214, e.g., in an alternating fashion. In another alternative, conductive support legs 211 are arranged both sides (first and second sides 213, 214) at the same point along the conductive strip 210. Furthermore, the conductive support legs 211 may be arranged differently relative to each other at different sections along the conductive strip 210.

In particular, the one or more conductive support legs 211 may comprise a first conductive support leg arranged extending from a first side 213 along the conductive strip 210 and a second conductive support leg arranged extending from a second side 214 along the conductive strip 210 that is opposite to the first side 213. Alternatively, the first conductive support leg arranged is extending from a first side 213 along the conductive strip 210 and the second conductive support leg is also arranged extending from the first side 213. In any case, the first conductive support leg may be distanced from the second conductive support leg by (2n−1)x, where n is any integer and x is 0.2-0.3 wavelengths, and preferably 0.25 wavelengths, of a selected frequency. Here, the distance is measured along the path the conductive strip 210 guides the electromagnetic waves when the conductive strip 210 is assembled with the first ground plane 220. In other words, along the signal path. The distance of (2n−1)x reduces the impact the first and the second conductive support legs have on the electromagnetic wave propagation properties, such as characteristic impedance, at the selected frequency. In another example, every conductive support leg 211 is periodically spaced apart with a period of a (2n−1)x.

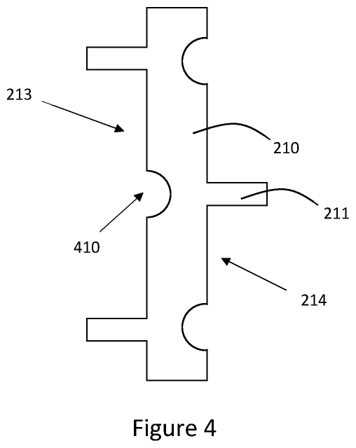

FIG. 4 shows a top view of an example conductive strip 210. This conductive strip 210 comprises three conductive support legs 211 extending from the first side and the second side 213, 214 in an alternate fashion. The conductive strip 210 further comprises a respective indentation for each conductive support leg 211, where each indentation is arranged on an opposite side of a corresponding conductive support leg 211. These indentations act as respective matching sections 410.

In general, the conductive strip 210 may be provided with at least one matching section 410 adjacent to at least one of the one or more conductive support legs 211. Here, “adjacent to” may e.g. mean within a distance corresponding to the width of the conductive strip 210. A matching section 410 is generally a section of the conductive strip 210 with a shape that deviates from the remainder of the conductive strip 210 such that the electromagnetic wave propagation characteristics of a transmission line comprising the conductive is locally affected. Consequently, the matching sections 410 may compensate for parasitics (such as parasitic capacitances and/or parasitic inductances) introduced by the conductive support legs 211. For example, the at least one matching section 410 may comprise an indentation and/or a bulge of the conductive strip 210.

The matching section 410 may be arranged on the same side of the conductive strip 210 as its corresponding conductive support leg 211, or on an opposite side to that conductive support leg 211. In particular, the one or more conductive support legs 211 may comprise the first conductive support leg arranged extending from a first side 213 along the conductive strip 210 and the at least one matching section 410 is arranged on a second side 214 along the conductive strip 210 that is opposite to the first side 213.

As mentioned, there is also disclosed herein a transmission line 200 comprising the conductive strip 210 and the first ground plane 220 according to the discussions above, where the conductive strip 210 is assembled with the first ground plane 220. In the transmission line 200, the conductive strip 210 is arranged galvanically isolated from the first ground plane 220 and at the distance from the first ground plane 220 via the one or more conductive support legs 211 such that the transmission line 200 is configured to guide electromagnetic waves between the conductive strip 210 and the first ground plane 220.

The transmission line 200 is preferably provided with gap between the conductive strip 210 and the first ground plane 220 comprising air. In general, however, any gas providing a low-loss transmission line 200 may occupy the space between the between the conductive strip 210 and the first ground plane 220. Alternatively, there may be a vacuum in that space.

The first ground plane 220 may be part of a PCB. As an example, the first ground plane 220 may be a layer of conductive foil on the PCB. In particular, the first ground plane 220 may an outermost layer of metal foil on the PCB.

As is shown in FIG. 2, at least one conductive patch 221 may be arranged in an opening 222 on the first ground plane 220 such that the at least one conductive patch 221 is galvanically isolated from the first ground plane 220. In that case, at least one of the one or more conductive support legs 211 may be soldered to one of the at least one conductive patch 221. If a metal foil on a substrate of a PCB constitutes the first ground plane 220, the conductive patch 221 may be etched out from the same metal foil. In that case, the conductive patch 221 is mechanically connected to the first ground plane 220 by the substrate of the PCB. A conductive patch 221 may be called a solder pad, and is galvanically isolated from the first ground plane 220 by a gap around the conductive patch 221.

Other ways of assembling the conductive strip 210 with the first ground plane 220 are also possible. In particular, at least one of the one or more conductive support legs 211 may be attached to the first ground plane 220 by an adhesive. If e.g. the adhesive is electrically conductive, a conductive support leg 211 attached by the adhesive is advantageously attached to a conductive patch 221 according to the discussion above. An example of an electrically conductive glue is silver epoxy. If, on the other hand, the adhesive galvanically isolates the conductive support leg 211 from whatever surface it is attached to, the conductive support leg 211 may advantageously be attached directly to the first ground plane 220.

As mentioned, FIGS. 3A and 3B show a stripline type transmission line comprising the disclosed conductive strip 210. In particular, FIG. 3B shows an exploded view of the transmission line 200 of FIG. 3A. The transmission line 200 of FIGS. 3A-3B is the same as the one shown in FIG. 2 except that a conductive cover has been added, which is encapsulating the conductive strip 210. Part of this cover acts as a second ground plane 330. More specifically, the planar surface of the cover facing the conductive strip 210 acts as the second ground plane 330. The side surfaces of the conductive cover comprises pins that are soldered to the first ground plane 220. A second ground plane 330 may have other shapes as well.

In general, the transmission line 200 may comprise a second ground plane 330 arranged at a distance from the conductive strip 210 such that the transmission line 200 is configured to guide electromagnetic waves between the conductive strip 210 and the second ground plane 330. The second ground plane 330 may be made from the same material as the first ground plane 220.

If the second ground plane 330 is part of a folded conductive sheet attached to the first ground plane 220, the folded conductive sheet may be arranged to at least partly encapsulate at least part of the conductive strip 210 between the first ground plane 220 and the folded conductive sheet. The folded conductive sheet may, as mentioned, be soldered to the first ground plane 220. Alternatively, or in combination of, the folded conductive sheet may be attached to the first ground plane 220 by an adhesive, or by other means. The folded conductive sheet optionally comprises pins that can be soldered to the first ground plane 220.

Furthermore, the first ground plane 220, the second ground plane 330, and the conductive strip 210 may be arranged such that the transmission line 200 is configured to guide electromagnetic waves between a lower surface of the conductive strip 210 and the first ground plane 220 and between an upper surface of the conductive strip 210 and the second ground plane 330. The lower surface of the conductive strip 210 is opposite to the upper surface of the conductive strip 210.

The folded conductive sheet comprising the second ground plane 330 may be dimensioned such that the wave propagation in the transmission line is similar to the wave propagation of an ideal air suspended stripline. In that case, the side surfaces (different from the second ground plane surface) of a rectangular folded conductive are arranged relatively far from the conductive strip, such as more than three times the width of the conductive strip 210. These side surfaces may alternative be arranged closer. In that case however, the transmission line 200 presents electromagnetic wave propagation properties that approaches the properties of a coaxial transmission line.

The second ground plane 330 is preferably electrically connected to the first ground plane 220 such that they act as a common ground, e.g. by a galvanic connection (e.g. from soldering) or by capacitive coupled grounding.

As mentioned, the conductive strip 210 may be planar. Similarly, the second ground plane 330 may be planar. In that case, the second ground plane 330 may be parallel with the conductive strip 210. Furthermore, the distance between the conductive strip 210 and the second ground plane 330 is normally based on the desired characteristic impedance of the transmission line 200. The distance may be constant along the conductive strip 210. Alternatively, the distance may vary along the conductive strip 210.

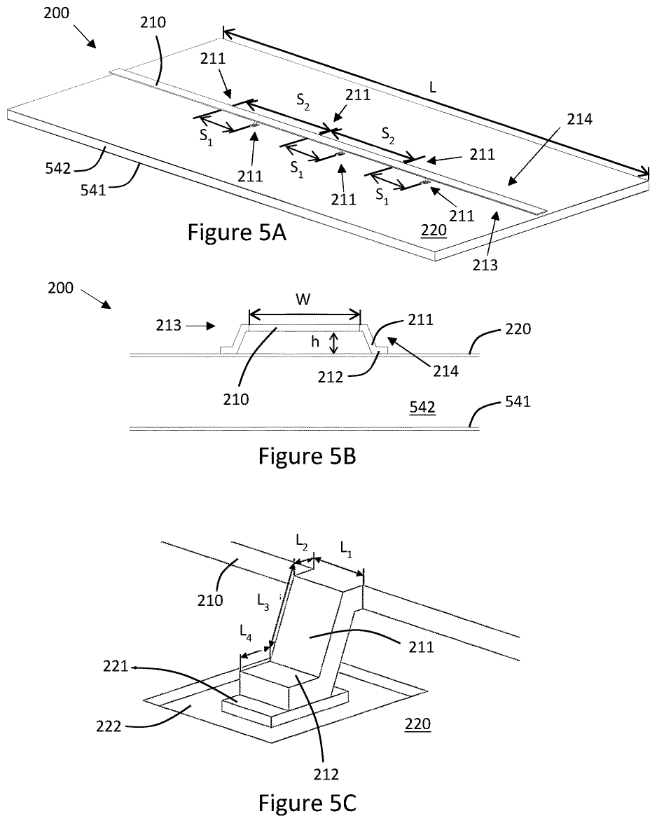

FIGS. 5-18 show different transmission lines and corresponding simulations of return loss and transmission loss. In all simulations, all conductive surfaces are copper. Below follows a more detailed description of FIGS. 5-18.

FIGS. 5A-5B show different views of an example transmission line 200. FIG. 5C shows details of a conductive support leg 211 from the example transmission line 200 of FIGS. 5A-5B. This example transmission line 200 can be seen as a type of microstrip. In particular, the transmission line 200 comprises a planar conductive strip 210 and a first ground plane 220, which is part of a PCB. The conductive strip 210 is parallel with the first ground plane 220. Furthermore, transmission line 200 is configured to guide electromagnetic waves between the conductive strip 210 and the first ground plane 220. The conductive strip 210 has a length L=100 mm and a width w=2.46 mm. The conductive strip 210 is arranged positioned at a height h=0.5 mm from the first ground plane 220. The conductive strip 210 comprises six conductive support legs 211. Three conductive support legs 211 are arranged extending from a first side 213 along the conductive strip 210 and the remainder of the conductive support legs 211 are arranged extending from a second side 214 along the conductive strip 210 that is opposite to the first side 213. The conductive support legs 211 are spaced apart from each other along the conductive strip 210 by s₁=10 mm and s₂=18 mm. The first ground plane 200 has a thickness of 70 μm.

The PCB of FIGS. 5A-5C further comprises a dielectric substrate 542 and a bottom ground plane 541. The dielectric substrate 542 and the bottom ground plane 541, however, have a neglectable effect on the wave propagation characteristics of the transmission line 200.

The conductive support legs 211 are monolithically formed with the conductive strip 210. Each conductive support leg 211 comprises a foot 212 arranged in galvanic contact (e.g. by soldering) to a respective conductive patch 221. All conductive patches 221 are arranged in respective openings 222 on the first ground plane 220. All conductive support legs 211 are galvanically isolated from the first ground plane 220. The conductive strip 210 and conductive support legs 211 have been formed from a metal sheet of a thickness of 0.15 mm. As shown in FIG. 5C, the conductive support legs 211 have the dimensions L₁=0.42 mm, L₂=0.17 mm, L₃=0.5048 mm, and L₄=0.26 mm.

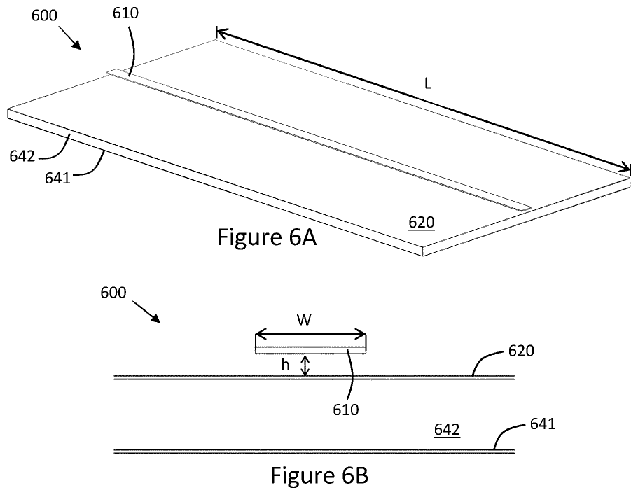

FIGS. 6A-6B show different views of an air microstrip 600 used as a reference. This air microstrip 600 is the same as the transmission line 200 of FIGS. 5A-5B, except that air microstrip 600 does not comprise any conductive support legs 211 and that the air microstrip 600 comprises a solid ground plane 620 without any openings with conductive patches. The conductive strip 610 of the air microstrip 600 has a length L=100 mm and a width w=2.46 mm, and is arranged positioned at a height h=0.5 mm from the solid ground plane 620. The PCB of FIGS. 6A and 6B comprises a dielectric substrate 642 and a bottom ground plane 641. The dielectric substrate 642 and the bottom ground plane 641, however, have a neglectable effect on the wave propagation characteristics of the air microstrip 600. The conductive strip 610 has a thickness of 0.15 mm.

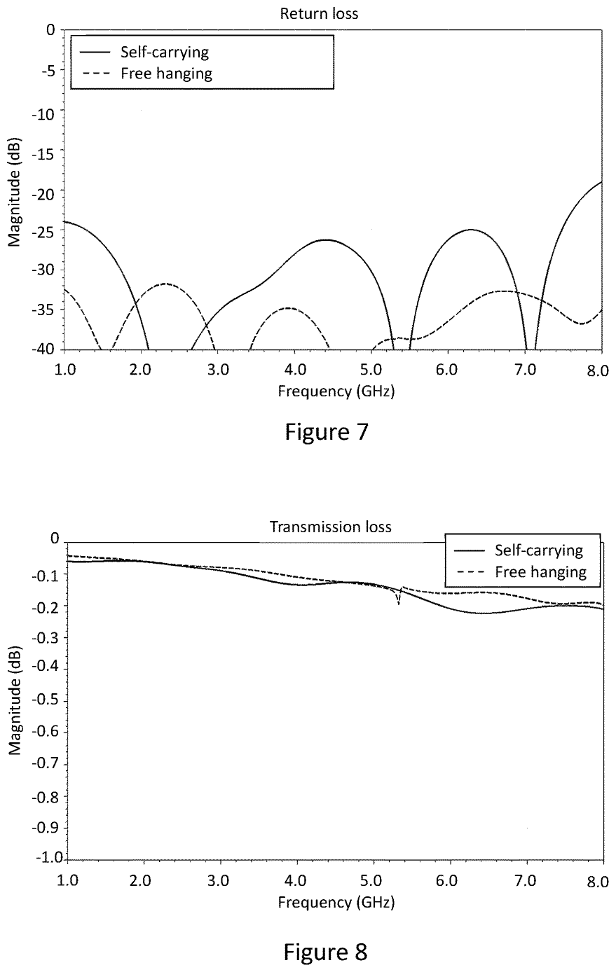

FIGS. 7 and 8 show simulated return losses and transmission losses, respectively, of the transmission line of FIGS. 5A-5B and of the air microstrip 600 of FIGS. 6A-6B. The simulations of the transmission line 200 of FIGS. 5A-5B are shown as solid lines and are denoted “self-carrying” in FIGS. 7-8. The simulations of the air microstrip 600 of FIGS. 6A-6B are shown as dashed lines and are denoted “free hanging” in FIGS. 7-8. By comparing the simulated results, it is seen that the conductive support legs 211 only have a small impact on the return loss and the transmission loss.

FIGS. 9A-9B show different views of an example transmission line 200. This example transmission line 200 can be seen as a type of stripline. This example transmission line 200 is the similar to the example transmission line 200 of FIGS. 5A-5B, except that the transmission line 200 of FIGS. 9A-9B additionally comprises a second ground plane 330. The conductive strip 210 has the same length L=100 mm, but has a width w=2.5 mm and the conductive strip 210 is now arranged positioned at a height h=0.96 mm from the first ground plane 220. The arrangement of the conductive support legs 211 are the same in FIGS. 9A-9B as in FIGS. 5A-5B.

In FIGS. 9A-9B, the conductive strip 210 is parallel with the first and the second ground planes 220, 330. The transmission line 200 is configured to guide electromagnetic waves between the conductive strip 210 and the first and the second ground planes 220, 330. The second ground plane 330 is part of a folded metal sheet with a thickness 0.15 mm. The folded metal sheet forms a rectangular and tubular shape with one open face, where the open face is arranged on the first ground plane 220 such that the folded metal sheet encapsulates the conductive strip 210 between the first ground plane 220 and the folded metal sheet. The folded metal sheet comprises a plurality of pins arranged galvanically connected (e.g. by soldering) to the first ground plane 220. The folded metal sheet has a width W=12 mm. This width is measured in plane parallel to the first ground plane 220 and in a direction perpendicular to the extension direction of the conductive strip 210. The folded metal sheet is arranged such its planar surface facing the first ground plane 220 is distanced from the first ground plane 220 by height H=2.07 mm.

FIGS. 10A-10B show different views of an air stripline 1000 used as a reference. This air stripline 1000 is the same as the transmission line 200 of FIGS. 9A-9B, except that air stripline 1000 does not comprise any conductive support legs 211 and that the air stripline 1000 comprises a solid ground plane 1020 without any openings with conductive patches. The conductive strip 1010 of the air stripline 1000 has a length L=100 mm and a width w=2.5 mm, and is arranged positioned at a height h=0.96 mm from the ground plane 1020. In addition, the folded metal sheet has a width W=12 mm and is distanced from the ground plane 1020 by height H=2.07 mm. The PCB of FIGS. 10A and 10B comprises a dielectric substrate 1042 and a bottom ground plane 1041. The dielectric substrate 1042 and the bottom ground plane 1041, however, have a neglectable effect on the wave propagation characteristics of the air stripline 1000. The conductive strip 1010 has a thickness of 0.15 mm.

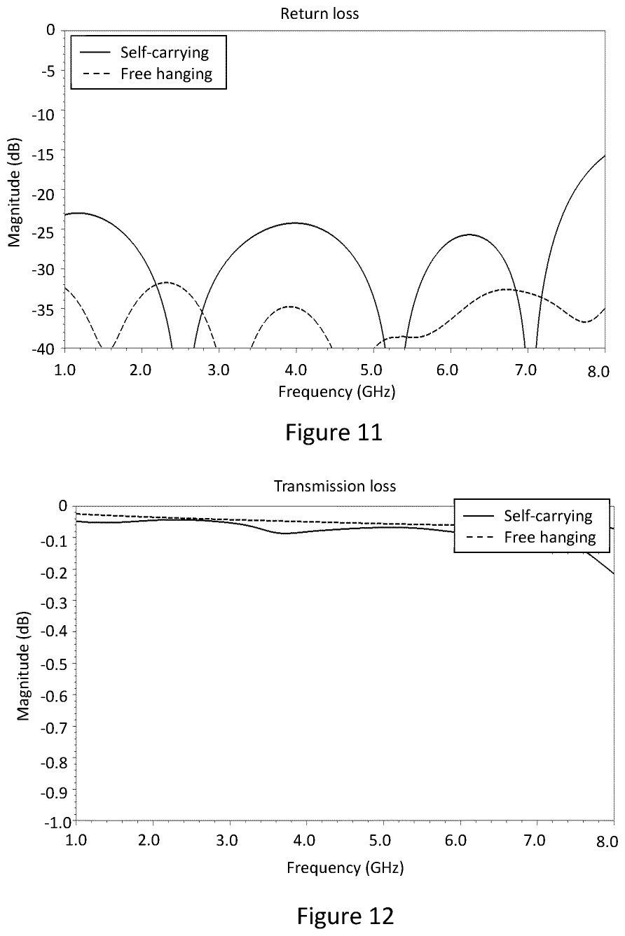

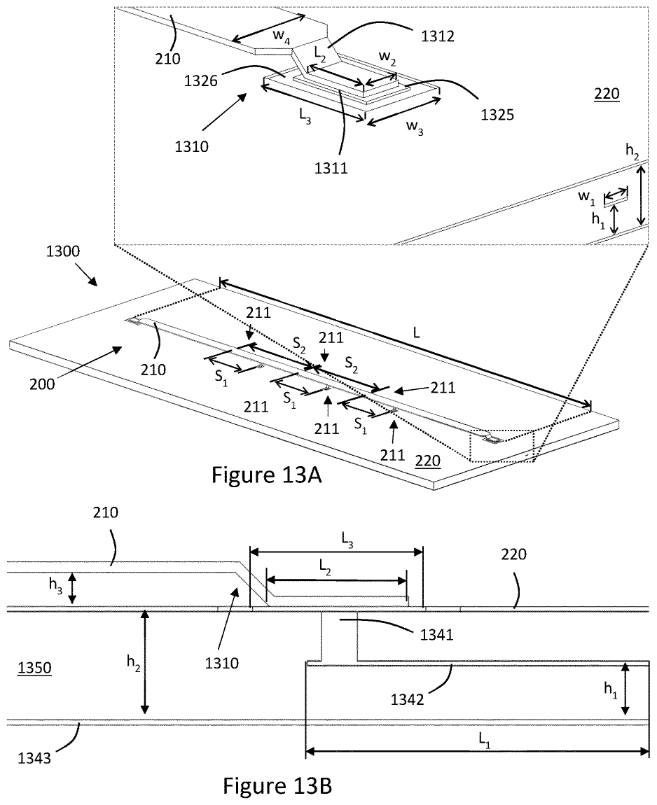

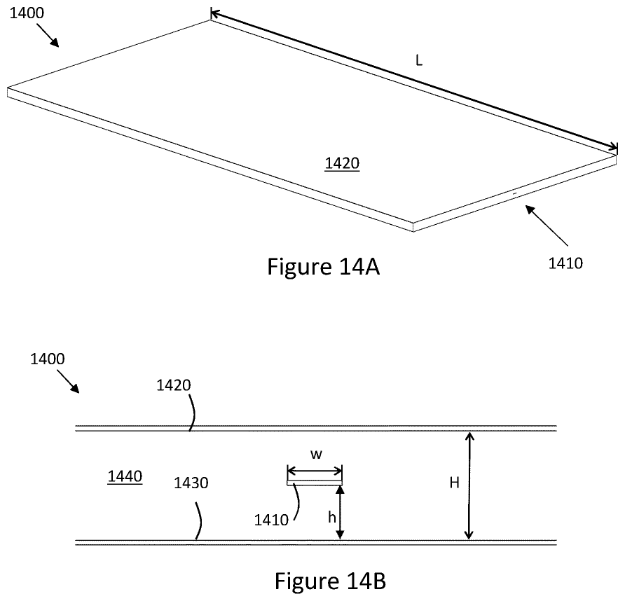

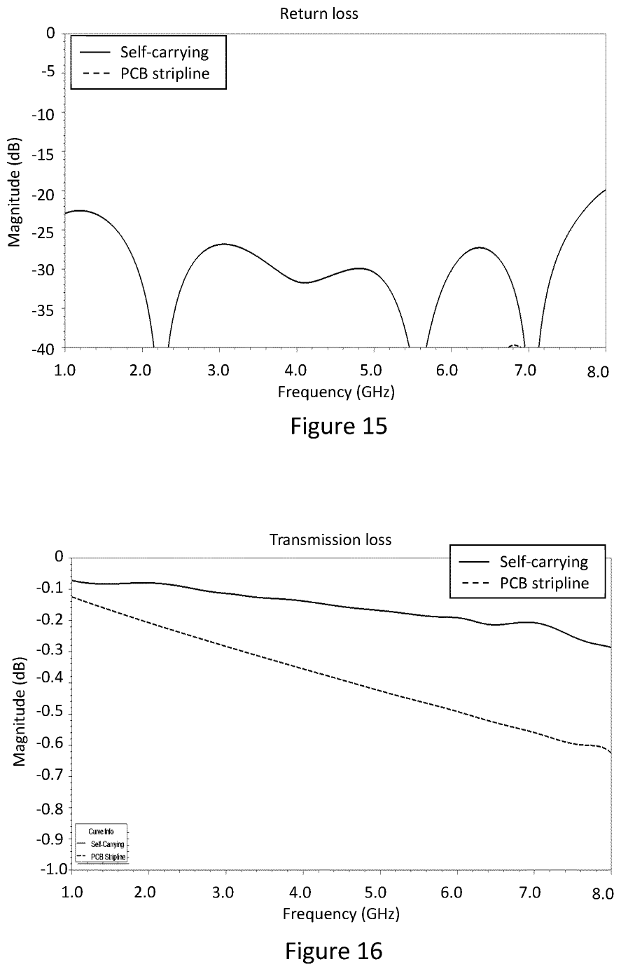

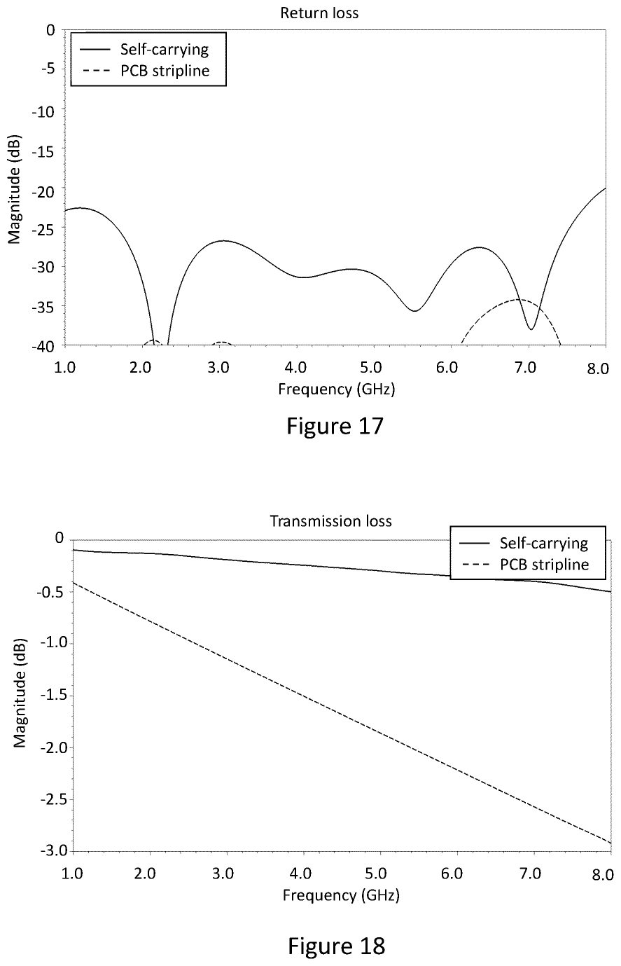

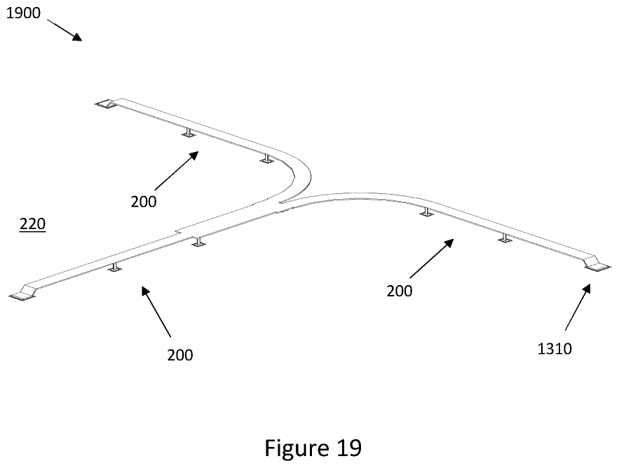

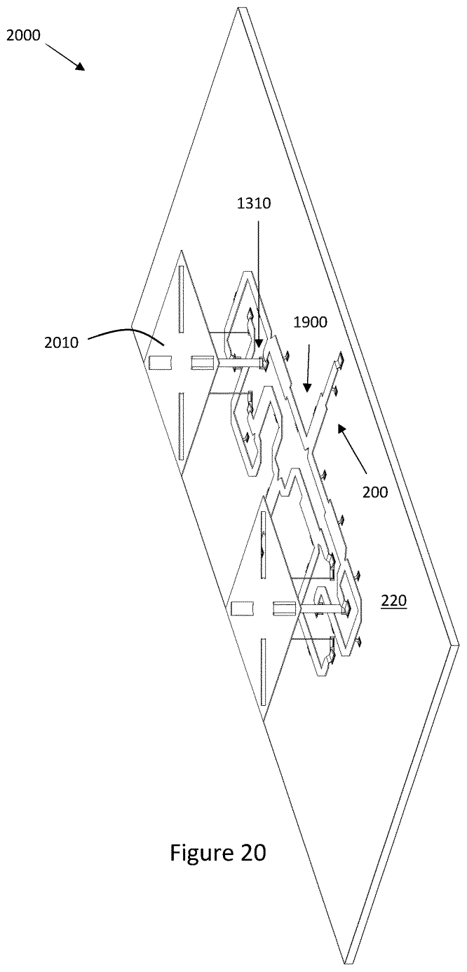

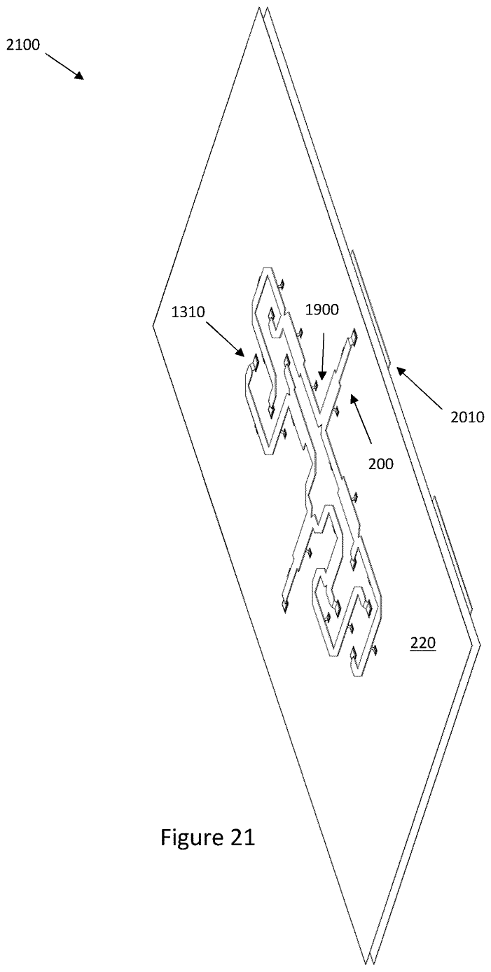

FIGS. 11 and 12 show simulated return losses and transmission losses, respectively, of the transmission line 200 of FIGS. 9A-9B and of the air stripline 1000 of FIGS. 10A-10B. The simulations of the transmission line 200 of FIGS. 9A-9B are shown as solid lines and are denoted “self-carrying” in FIGS. 11-12. The simulations of the air stripline 1000 of FIGS. 10A-10B are shown as dashed lines and are denoted “free hanging” in FIGS. 11-12. By comparing the simulated results, it is seen that the conductive support legs 211 only have a small impact on the return loss and the transmission loss.

Generally, the transmission line 200 may comprise at least one signal transition 1310 from the conductive strip 210 to the PCB. Such signal transition 1310 may be used to direct electromagnetic waves guided by the transmission line 200 to other layers of the PCB and/or to various components such as antenna elements. FIGS. 13A-13B show different views of an example transmission line arrangement 1300 and details of a signal transition 1310. The transmission line arrangement comprises a transmission line 200 similar to the one of FIGS. 5A-5B. The transmission line arrangement 1300 comprises signal transitions 1310 at each end of the conductive strip 210. Measured at the respective ends of the signal transitions 1310, the conductive strip 210 has a length L=100 mm. The conductive strip 210 (without signal transitions 1310) has a width w₄=2.46 mm. The conductive strip 210 is positioned at a height h₃=0.5 mm from the first ground plane 220. Each signal transition 1310 is an integral part of the conductive strip 210 and comprises a foot 1311 arranged parallel to the first ground plane 220. Each foot 1311 is physically and electrically connected to the conductive strip 210 via respective bends 1312. Each foot 1311 is galvanically connected (e.g. by soldering) to a respective conductive patch 1325 arranged in respective openings 1326 on the first ground plane 220. Each foot has a width w₂=1.2 mm (measured in the same direction as the width of the conductive strip 210) and a length L₂=1.938 mm. Each opening 1326 comprising the respective conductive patches 1325 has a width w₃=2.5 mm (measured in the same direction as the width of the conductive strip 210) and a length L₃=3.5 mm.

As is also shown in FIGS. 13A-13B, each conductive patch 1325 comprises a via hole 1341 connected to a PCB stripline (i.e. a stripline embedded in a dielectric substrate 1350 of the PCB). This PCB stripline is formed by a conductive strip 1342, the first ground plane 220 and a bottom ground plane 1343. The conductive strip 1342 has a width w₁=0.785 mm (measured in the same direction as the width of the conductive strip 210) and a length L₁=9.46 mm. The conductive strip 1342 is positioned at a height h₁=0.785 mm from the bottom ground plane 1343. The bottom ground plane 1343 is positioned at a height h₂=1.57 mm from the first ground plane 220.

FIGS. 14A-14B show different views of an example PCB stripline 1400 (i.e. a stripline embedded in a dielectric substrate 1440 of the PCB) used as a reference. The PCB stripline 1400 is formed by a conductive strip 1410, a top ground plane 1420, and a bottom ground plane 1430. The conductive strip 1410 has a width w=0.785 mm (measured in a direction perpendicular to the extension direction of the conductive strip 1410), a length L=100 mm and a thickness of 0.15 mm. The conductive strip 1410 is positioned at a height h=0.785 mm from the bottom ground plane 1430. The bottom ground plane 1430 is positioned at a height H=1.57 mm from the top ground plane 1420.

FIGS. 15 and 16 show simulated return losses and transmission losses, respectively, of the transmission line arrangement of FIGS. 13A-13B and of the PCB stripline 1400 of FIGS. 14A-14B. The simulation results of the transmission line arrangement of FIGS. 13A-13B are shown as solid lines and are denoted “self-carrying” in FIGS. 15-16. The simulation results of the PCB stripline 1400 of FIGS. 14A-14B are shown as dashed lines and are denoted “free hanging” in FIGS. 15-16. In these simulations, the dielectric substrates 1350 and 1440 have a dielectric constant εr=3.45 and a dissipation factor tan δ=0.0031. It can be concluded from these simulations that the transmission losses can be significantly reduced when a part of a PCB stripline is replaced with the disclosed transmission line 200. Note that the simulated transmission loss for the transmission line 200 of FIGS. 13A-13B includes the losses of the signal transitions 1310 from the PCB stripline to the disclosed transmission line 200. The losses of the PCB stripline formed by the conductive strip 1342 are not included.

As mentioned, the simulations in FIGS. 15 and 16 assume a dielectric substrate with εr=3.45 and tan δ=0.0031, which represent a relatively low-loss substrate. In some cases, however, it is attractive to use low-cost dielectric substrates, which normally have the drawback of having higher losses. FIGS. 17 and 18 show simulated results for the same cases as in FIGS. 13A-13B and of FIGS. 14A-14B, except that a dielectric substrate with dissipation factor tan δ=0.02 is now assumed. As seen from results, the transmission losses for the reference case becomes considerably higher and thus the difference between the cases in cases as in FIGS. 13A-13B and of FIGS. 14A-14B is significantly higher compared to the simulations shown in FIGS. 15 and 16. Note that the different scales on the y-axes in FIGS. 16 and 18.

The disclosed transmission line 200 may be used for transmission line networks that are relatively more complex compared to the previously mentioned examples. Therefore, there is also disclosed herein a feed network comprising at least one transmission line 200. FIG. 19 shows an example feed network 1900. This feed network 1900 is a power splitter comprising a transmission line that is split in two. In other words, it comprises three transmission lines with respective ends connected at one node. Each end of the three-port network comprise a respective signal transition 1310 from a respective end of the conductive strip 210 to the first ground plane 220. Generally, the feed network 1900 may comprise any number of transmission lines 200 forming a network with any number of ports. In particular, the disclosed feed network 1900 may comprise a plurality of transmission lines 200 forming a power splitter and/or a power combiner.

There is also disclosed herein an antenna arrangement comprising at least one feed network 1900 and at least one antenna element. The at least one feed network 1900 is arranged to guide electromagnetic waves to and/or from the at least one antenna element. FIGS. 20 and 21 show respective example antenna arrangement 2000 and 2100. Both antenna arrangements 2000, 2100 comprise a feed network comprising a plurality of transmission lines 200. The feed network is arranged on a PCB where an outermost layer of the PCB constitutes the first ground plane 220. In FIG. 20, the antenna elements 2010 are arranged on the same surface of a layer of the PCB as the feed network 1900. The antenna elements 2010 are excited via signal transitions 1310 of the feed network 1900. In particular, the signal transitions electrically connects ends of the conductive strips 210 to respective traces on the PCB. The traces are electrically connected to the antenna elements 2010. In FIG. 21, the antenna elements 2010 are arranged on a surface of the PCB that is opposite to the surface with the feed network 1900. Here, the antenna elements 2010 are also excited via signal transitions 1310 of the feed network 1900. In this case, the traces are connected to the opposite surface of the PCB using via holes.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

1. A conductive strip for assembly with a first ground plane to form a transmission line the conductive strip comprising one or more conductive support legs, wherein the one or more conductive support legs are arranged to hold the conductive strip positioned at a distance from the first ground plane such that the transmission line is configured to guide electromagnetic waves between the conductive strip and the first ground plane when the conductive strip is assembled with the first ground plane.

2. The conductive strip of claim 1, wherein the one or more conductive support legs are arranged to be galvanically isolated from the first ground plane when the conductive strip is assembled with the first ground plane.

3. The conductive strip of claim 1, wherein at least one of the one or more conductive support legs is monolithically formed with the conductive strip.

4. The conductive strip of claim 1, wherein at least one of the one or more conductive support legs comprises a foot for soldering onto a conductive patch

5. The conductive strip of claim 1, wherein the conductive strip is planar.

6. The conductive strip of claim 4, wherein the one or more conductive support legs comprise a first conductive support leg arranged extending from a first side along the conductive strip and a second conductive support leg arranged extending from a second side along the conductive strip that is opposite to the first side.

7. The conductive strip of claim 4, wherein the one or more conductive support legs comprise a first conductive support leg arranged extending from a first side along the conductive strip and a second conductive support leg arranged extending from the first side.

8. The conductive strip of claim 6, wherein the first conductive support leg is distanced from the second conductive support leg by (2n−1)x, where n is any integer and x is 0.2-0.3 wavelengths, and preferably 0.25 wavelengths, of a selected frequency.

9. The conductive strip of claim 1, wherein the conductive strip is provided with at least one matching section adjacent to at least one of the one or more conductive support legs.

10. The conductive strip of claim 6, wherein
the conductive strip is provided with at least one matching section adjacent to at least one of the one or more conductive support legs, and
the one or more conductive support legs comprise the first conductive support leg arranged extending from a first side along the conductive strip and the at least one matching section is arranged on a second side along the conductive strip that is opposite to the first side.

11. The conductive strip of claim 9, wherein the at least one matching section comprises an indentation and/or a bulge of the conductive strip.

12. A transmission line comprising:
a first ground plan; and
a conductive strip assembled with and galvanically isolated from the first ground plane, wherein
the conductive strip comprises a set of one or more conductive support legs, and
the set of conductive support legs are arranged to hold the conductive strip positioned at a distance from the first ground plane such that the transmission line is configured to guide electromagnetic waves between the conductive strip and the first ground plane.

13. The transmission line of claim 12, wherein a gap between the conductive strip and the first ground plane comprises air.

14. The transmission line of claim 12, wherein at least one of the conductive support legs is attached to the first ground plane by an adhesive.

15. The transmission line of claim 12, wherein at least a first conductive patch is arranged in an opening on the first ground plane such that the first conductive patch is galvanically isolated from the first ground plane, wherein at least one of the conductive support legs is soldered to the first conductive patch.

16. The transmission line of claim 12, further comprising a second ground plane arranged at a distance from the conductive strip such that transmission line is configured to guide electromagnetic waves between the conductive strip and the second ground plane.

17. The transmission line of claim 16, wherein the first ground plane, the second ground plane, and the conductive strip are arranged such that the transmission line is configured to guide electromagnetic waves between a lower surface of the conductive strip and the first ground plane and between an upper surface of the conductive strip and the second ground plane, wherein the lower surface of the conductive strip is opposite to the upper surface of the conductive strip.

18. The transmission line of claim 16, wherein the second ground plane is part of a folded conductive sheet attached to the first ground plane, where the folded conductive sheet is arranged to at least partly encapsulate at least part of the conductive strip between the first ground plane and the folded conductive sheet.

19. The transmission line of claim 12, wherein the first ground plane is part of a printed circuit board, PCB.

20. The transmission line of claim 19, comprising at least one signal transition from the conductive strip to the PCB.

21. A feed network comprising the transmission line of claim 12.

22. (canceled)

23. An antenna arrangement comprising:
the feed network of claim 21; and
at least one antenna element, wherein
the feed network is arranged to guide electromagnetic waves to and/or from the at least one antenna element.
